(19) United States
(12) Patent Application Publication
(10) Pub. No.: US 2020/0152035 A1
(43) Pub. Date: May 14, 2020

(54) REMOTE DISASTER PREVENTION SYSTEM

(71) Applicant: Gyoung Su KIM, Gyeonggi-do (KR)

(72) Inventor: Gyoung Su KIM, Gyeonggi-do (KR)

(21) Appl. No.: 16/610,465

(22) PCT Filed: May 8, 2018
(86) PCT No.: PCT/KR2018/005255

§ 371 Date: Nov. 1, 2019

(30) Foreign Application Priority Data
May 10, 2017 (KR) 10-2017-0057875

(51) Int. Cl. G08B 17/12; H04N 7/18; G08B 7/06; H04M 1/725

(52) U.S. Cl. CPC G08B 17/125; H04N 7/181; H04M 1/72583; G08B 7/062; H04M 1/72541; G08B 7/066

(57) ABSTRACT

A remote disaster prevention system includes a fire detector installed in each zone of a building to detect a fire and transmit a detected result to a fire-signal receiving section, a CCTV camera installed in each zone to transmit a photographed CCTV image to the fire-signal receiving section, the fire-signal receiving section coupled to the fire detector and the CCTV camera to notify a fire outbreak message including a fire outbreak zone and the CCTV image to a manager's mobile phone when a fire is detected from the fire detector, a manager's mobile phone that is a mobile phone used by a manager and displays the fire outbreak message received from the fire-signal receiving section and a CCTV image of the fire outbreak zone, and a mobile communication network to provide mobile communication between the fire-signal receiving section and the manager's mobile phone.

### BACKGROUND

The present invention relates to a disaster prevention system. More particularly, the invention relates to a remote disaster prevention system, intended to cope with a fire disaster at a remote location.

According to a recent fire analysis, it is reported that 24.3% of all fire accidents and 60.7% of fire deaths occur in houses and the percentage of people killed by fires in detached houses reaches 83.5%.

Hence, according to Article 8 of the Act on fire prevention, installation and maintenance of fire extinguishing facilities, and safety management, it was mandatory to install fire-fighting facilities for residential buildings by Feb. 4, 2017. Thus, houses such as detached houses, multi-household house, row houses, or multiplex houses should have at least one fire extinguisher in every house or floor, and a fire detector should be installed in each of divided rooms. Such a fire detector automatically gives an alarm if smoke is detected, and transmits a fact that a fire breaks out to a fire-signal receiving section.

The fire-signal receiving section should be installed at a place where people work in normal times to rapidly cope with a fire in the event of the fire. Most of multi-complex buildings such as small apartments or buildings are open at night, but concerned people and building managers may leave work at night or may be out of an office for a while in the daytime. This is problematic in that it is difficult to rapidly cope with a fire in the event of the fire. Therefore, there is an urgent need for a means that can rapidly propagate a fact that the fire breaks out to external concerned people and managers.

### PRIOR ART DOCUMENT

Korean Laid-Open Patent Publication No. 10-2008-0054368

### SUMMARY OF THE INVENTION

Accordingly, the present invention has been made keeping in mind the above problems occurring in the related art, and is intended to provide a means configured to cope with a fire at a remote location by rapidly propagating a fact that the fire breaks out to external concerned people and managers.

In order to accomplish the above object, the present invention provides a remote disaster prevention system including a fire detector installed in each zone of a building to detect a fire and transmit a detected result to a fire-signal receiving section; a CCTV camera installed in each zone of the building to transmit a photographed CCTV image to the fire-signal receiving section; the fire-signal receiving section coupled to the fire detector and the CCTV camera installed in each zone to notify a fire outbreak message including a fire outbreak zone and the CCTV image to a manager's mobile phone when a fire is detected from the fire detector; a manager's mobile phone that is a mobile phone used by a manager and displays the fire outbreak message received from the fire-signal receiving section and a CCTV image of the fire outbreak zone; and a mobile communication network configured to provide mobile communication between the fire-signal receiving section and the manager's mobile phone.

The fire-signal receiving section may transmit a building-zone image with zones being separately marked, and the manager's mobile phone may display a fire outbreak zone in the building-zone image such that it may be different from other zones where no fire breaks out.

The manager's mobile phone may display the CCTV image of a fire outbreak zone that is touched, when the fire outbreak zone in the building-zone image is touched.

The manager's mobile phone may estimate an evacuation route to allow people to be evacuated from the fire outbreak zone to an emergency exit, thus displaying the evacuation route in the building-zone image.

The manager's mobile phone may previously register and store position information of each zone in the building and position information of the emergency exit, and estimation of the evacuation route may determine a shortest route along which people may be evacuated from the fire outbreak zone to the emergency exit.

The estimation of the evacuation route may estimate a flame percentage in each zone, which is a percentage of an image size of flame occupied in the zone, using the CCTV image of each zone, and may determine a route to allow people to pass through a zone which is lower in flame percentage than a preset threshold, among a plurality of routes along which people are evacuated from the fire outbreak zone to the emergency exit.

The remote disaster prevention system may include a speaker installed in each zone of the building, the manager's mobile phone may display the CCTV image and a voice guidance button, and the manager's guidance voice for guiding people to the evacuation route may be transmitted to the fire-signal receiving section after the voice guidance button is pressed down, and the fire-signal receiving section may output the manager's voice for guiding the evacuation route through the speaker installed in the fire outbreak zone.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating the configuration of a remote disaster prevention system in accordance with an embodiment of the present invention;

FIG. 2 is a block diagram illustrating the configuration of a manager's mobile phone in accordance with the embodiment of the present invention;

FIG. 3 is a diagram illustrating the manager's mobile phone to show the images of zones of a building in accordance with the embodiment of the present invention;

FIG. 4 is a diagram illustrating the manager's mobile phone to show a CCTV image in accordance with the embodiment of the present invention;

FIG. 5 is a diagram illustrating the manager's mobile phone to show a shortest evacuation route in accordance with the embodiment of the present invention;

FIG. 6 is a diagram illustrating a state where an announcement for evacuation is output through a speaker to a fire outbreak zone in accordance with the embodiment of the present invention; and

FIG. 7 is a diagram illustrating the manager's mobile phone to show the evacuation route along which people are evacuated through a low flame zone in accordance with the embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, the advantages and features of the present invention and the method for achieving them will become apparent with reference to embodiments that will be described below in detail in conjunction with the accompanying drawings. However, the present invention is not limited to embodiments that will be described below but may be embodied in different forms. Embodiments are provided to thoroughly inform those skilled in the art of the scope of the invention, and the present invention is merely defined by the scope of claims. Furthermore, in the description of the present invention, if it is determined that related known technologies may obscure the gist of the present invention, a detailed description thereof will be omitted herein.

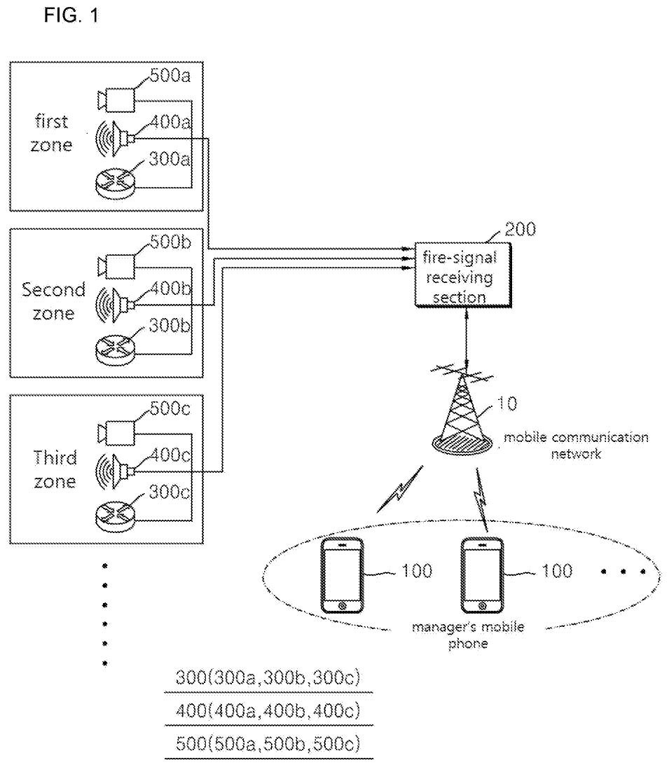

FIG. 1 is a view illustrating the configuration of a remote disaster prevention system in accordance with an embodiment of the present invention.

It may be practically difficult to control the disaster prevention of small- and medium-scale buildings that are to be protected against a fire. Furthermore, concerned people or personnel may leave for business trips, go on vacations or leave work. In this case, the present invention is intended to prevent a disaster prevention system from shutting down. When a fire breaks out or an alarm is raised due to the fire, this may be transmitted through a network to a mobile phone of each of concerned people or all managers, in which an application (app) is installed, to rapidly cope with the fire and consequently protect lives and properties.

In other words, the present invention links the disaster prevention system installed in the building and a manager's mobile phone 100 through the app, thus allowing all concerned people each having the manager's mobile phone 100 in which a fire disaster prevention application 150 is installed to control the disaster prevention system via two-way communication.

When the disaster prevention system of the present invention is operated, this operation signal is sent through the network to each of the mobile phones of all concerned people, in which the fire disaster prevention application 150 is installed, and each of the mobile phones of all concerned people receiving the signal raises an alarm, thus displaying a floor or a zone from which the signal is sent.

If the displayed zone is touched, a scene may be checked through a CCTV installed in the building. Furthermore, all concerned people connected with the network may be connected in the same call to rapidly cope with the disaster. In the event of emergency, the manager may report to a relevant government office, a phone number of which is stored in the manager's mobile phone 100. Regardless of the current position of the manager, he or she may immediately operate emergency broadcasting installed in the building via the manager's mobile phone 100 to instruct an initial response, an evacuation method and others.

Furthermore, if the function of a receiver is stopped optionally or stopped due to its failure, it is immediately notified to a comprehensive disaster prevention system of a relevant government office through the network, and the relevant government office may frequently monitor the status of the building by making a call with the concerned people or managers of the relevant building with a single touch. This can always keep the disaster prevention system to be operated, thus guaranteeing the best safety.

To this end, as illustrated in FIG. 1, the remote disaster prevention system of the present invention may include a fire detector 300, a CCTV camera 500, a speaker 400, a fire-signal receiving section 200, the manager's mobile phone 100, and a mobile communication network 10.

The fire detector 300 is installed in each zone in the building to detect a fire and transmit a detected signal to the fire-signal receiving section 200. For example, a first fire detector 300a is installed in a first zone, a second fire detector 300b is installed in a second zone, and a third fire detector 300c is installed in a third zone. As such, a separate fire detector is installed in each zone in the building. In order to install the fire detector, various installing methods may be applied, for example, a ceiling embedding method, a ceiling protruding method, a wall embedding method, a wall protruding method, etc.

The CCTV camera 500 is installed in each zone of the building to transmit a photographed CCTV image to the fire-signal receiving section 200. For example, a first CCTV camera 500a is installed in the first zone, a second CCTV camera 500b is installed in the second zone, and a third CCTV camera 500c is installed in the third zone to photograph each zone and then transmit it to the fire-signal receiving section 200.

For reference, the CCTV camera 500 may include a lens assembly, a filter, a photoelectric conversion module, and an analog/digital conversion module. The lens assembly includes a zoom lens, a focus lens and a compensation lens. The filter blocks the optical noise of a high-frequency component and the infrared component of incident light. The photoelectric conversion module includes an imaging device, such as a Charge Coupled Device (CCD) or a Complementary Metal-Oxide-Semiconductor (CMOS) to convert light from an optical system (OPS) into an electrical analog signal. The analog/digital conversion module processes an analog signal from the photoelectric conversion module, removes a high-frequency noise, controls amplitude, and converts it into a digital signal.

The speaker 400 is installed in each zone of the building to output a manager's voice that guides an evacuation route. Therefore, people who are in a fire outbreak zone are evacuated to the evacuation route according to the manager's voice for guiding the evacuation route, which is output through the speaker 400.

The fire-signal receiving section 200 is a fire monitoring device that is connected to the fire detector 300 and the CCTV camera 500 installed in each zone. The fire-signal receiving section 200 may be connected to the fire detector 300 and the CCTV camera 500 via a wired/wireless communication network, which may use a wired communication method such as Ethernet, Universal Serial Bus, IEEE 1394, serial communication and parallel communication, and a wireless communication method such as Infrared Radiation, Bluetooth, home RF (Radio Frequency) and Wireless LAN. When detecting the fire from the fire detector, a fire outbreak message including the fire outbreak zone and the CCTV image is transmitted to the manager's mobile phone 100. Moreover, the fire-signal receiving section 200 may be provided with an indication lamp indicating the fire detection of each fire detector, a manager control panel, and an alarm buzzer. For example, if the fire detection is received from the first fire detector 300a that is provided in the first zone, the CCTV image of the first zone and the fire outbreak of the first zone are notified to the manager's mobile phone 100.

Furthermore, the fire-signal receiving section 200 also transmits images of building zones with the zones being separately marked. Thus, a fire outbreak zone in the building-zone image may be displayed on the manager's mobile phone 100 so that it is different from other zones where no fire breaks out. The manager's mobile phone 100 is a mobile phone that is used by a manager, and may include all kinds of terminals facilitating mobile communication, such as a tablet PC or a slate PC, in addition to a smart-phone illustrated in the drawings. The manager's mobile phone 100 displays the fire outbreak message received from the fire-signal receiving section 200, and also displays the CCTV image of the fire outbreak zone.

The mobile communication network 10 provides mobile communication between the fire-signal receiving section 200 and the manager's mobile phone 100. Thus, data communication may be performed between the fire-signal receiving section 200 and the manager's mobile phone 100 using the mobile communication network 10 composed of a Base Transceiver Station (BTS), a Mobile Switching Center (MSC), and a Home Location Register (HLR).

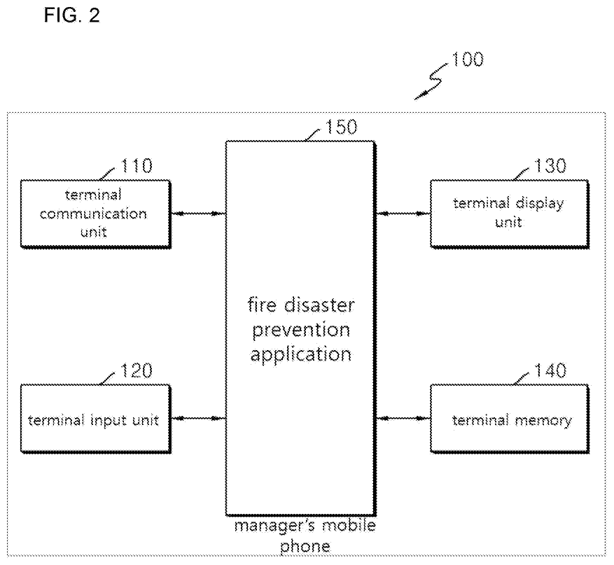

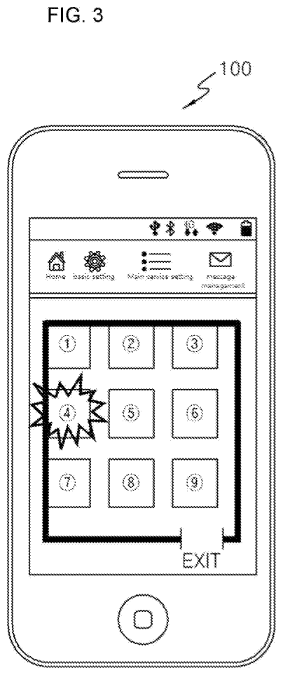

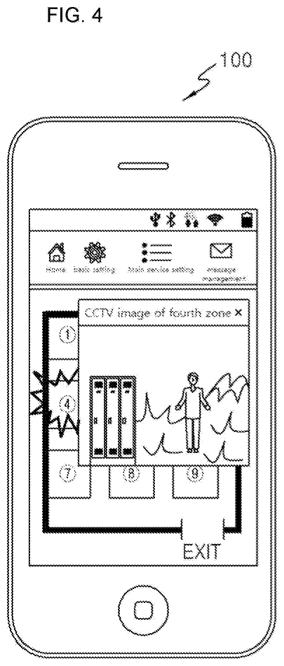

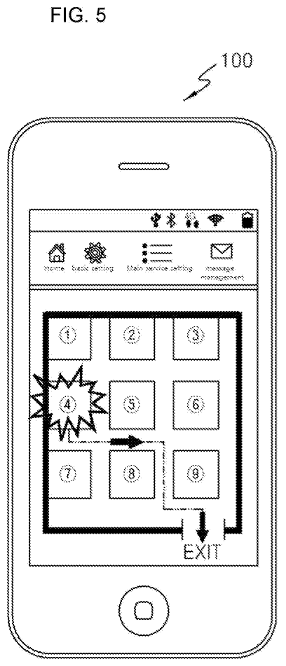

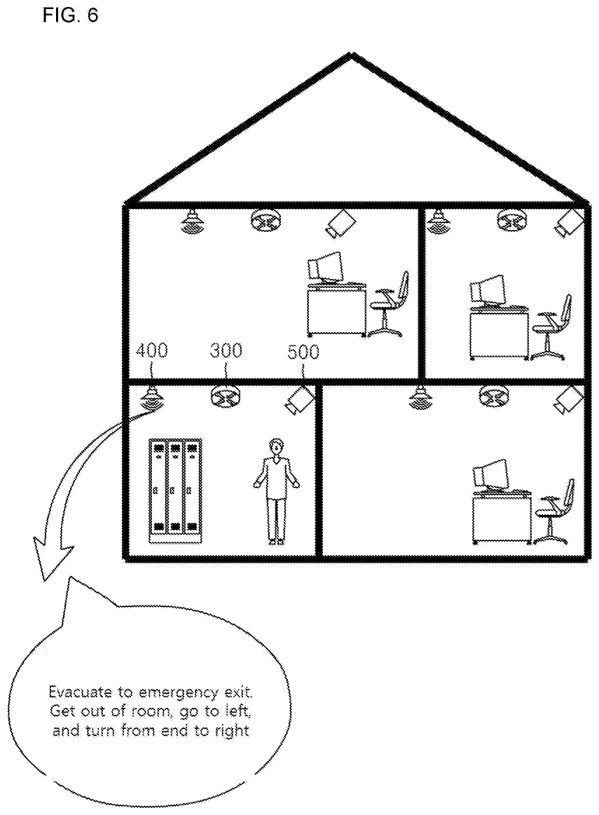

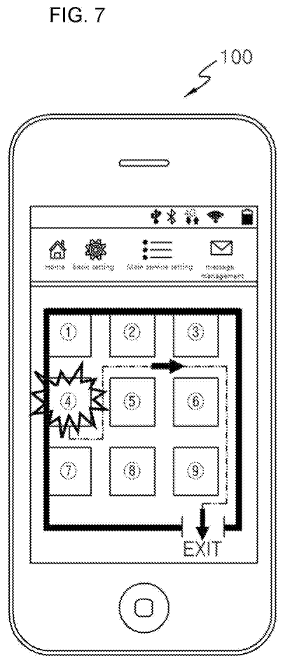

FIG. 2 is a block diagram illustrating the configuration of the manager's mobile phone in accordance with the embodiment of the present invention, FIG. 3 is a diagram illustrating the manager's mobile phone to show the images of the zones of the building in accordance with the embodiment of the present invention, FIG. 4 is a diagram illustrating the manager's mobile phone to show the CCTV image in accordance with the embodiment of the present invention, FIG. 5 is a diagram illustrating the manager's mobile phone to show a shortest evacuation route in accordance with the embodiment of the present invention, FIG. 6 is a diagram illustrating a state where an announcement for evacuation is output through the speaker to the fire outbreak zone in accordance with the embodiment of the present invention, and FIG. 7 is a diagram illustrating the manager's mobile phone to show the evacuation route along which people are evacuated through a low flame zone in accordance with the embodiment of the present invention.

As illustrated in FIG. 2, the manager's mobile phone 100 may include a terminal communication unit 110, a terminal input unit 120, a terminal display unit 130, a terminal memory 140, and the fire disaster prevention application 150. The terminal communication unit 110 is a module for performing mobile communication with the external fire-signal receiving section 200 through the mobile communication network 10. In the case of performing the mobile communication of 3G, 4G or the like, the terminal communication unit includes an RF transmitter (not shown) that up-coverts and amplifies the frequency of a wirelessly transmitted signal, an RF receiver (not shown) that low-noise amplifies a received wireless signal and down-coverts the frequency, etc. The terminal input unit 120 is a module into which the manipulation command of the manager is input, and the terminal display unit 130 is a module which displays the building-zone image, the CCTV image, and the fire outbreak fact, which are received from the fire-signal receiving section 200. The terminal input unit 120 and the terminal display unit 130 may be implemented in the form of a single touch screen panel. The touch screen panel is a display window that provides a touch screen for simultaneously performing input and display operations, is provided on the front of the terminal, and displays a work screen. This displays a Graphic User Interface (GUI) for communicating with the manager.

The terminal memory 140 is a storage in which the position information of each zone in the building managed by the fire-signal receiving section 200 and the position information of an emergency exit are previously registered and stored. In addition, the received CCTV image may be stored by date. Here, the terminal memory 140 is a module that may input and output information, such as a Solid State Drive, a Flash Memory, a Compact Flash Card, a Secure Digital Card, a Smart Media Card, a Multi-Media Card or a Memory Stick. The terminal memory may be provided in the manager's mobile phone 100 or in a separate device.

The fire disaster prevention application 150 is the app that displays the fire outbreak message received from the fire-signal receiving section 200 and in addition, displays the CCTV image of the fire outbreak zone. For reference, hundreds of applications (apps) may be installed in, added to or removed from the manager's mobile phone 100 implemented as the smartphone as desired, so that it is possible to directly create a desired application and to implement an interface suitable for the user through various applications. Therefore, the fire disaster prevention application 150 may be downloaded from a google market, an apple store or the like and then installed in the manager's mobile phone 100.

If the fire-signal receiving section 200 transmits the building-zone image with the zones being separately marked, the fire disaster prevention application 150 of the manager's mobile phone 100 displays the fire outbreak zone in the building-zone image so that it is different from other zones where no fire breaks out. For example, when the fire breaks out in a fourth zone as illustrated in FIG. 3, a fire outbreak mark may be displayed in the fourth zone. Thus, the manager can easily and intuitively see the fire outbreak zone in the displayed building-zone image.

Furthermore, when the fire outbreak zone in the building-zone image is touched, the fire disaster prevention application 150 of the manager's mobile phone 100 displays the CCTV image of the touched fire outbreak zone. For instance, when the manager touches the fourth zone where the fire breaks out, as illustrated in FIG. 4, the CCTV image of the fourth zone is displayed. Therefore, the manager may monitor the fire scene of the fire outbreak zone in real time and then take proper action.

Further, the fire disaster prevention application 150 of the manager's mobile phone 100 may estimate the evacuation route along which people may be evacuated from the fire outbreak zone to the emergency exit, and then may display the evacuation route in the building-zone image. For example, as illustrated in FIG. 5, when the fire breaks out in the fourth zone, the evacuation route along which people may be evacuated most rapidly from the fourth zone may be displayed on the building-zone image. This helps the manager to check the relevant evacuation route and then provide voice guidance for informing people in the fire zone of the evacuation direction.

In other words, the fire disaster prevention application 150 of the manager's mobile phone 100 displays the CCTV image as well as a voice guidance button. After the voice guidance button is pressed down, the manager's guidance voice for guiding people to the evacuation route is transmitted to the fire-signal receiving section 200. As illustrated in FIG. 6, the fire-signal receiving section 200 outputs the manager's voice for guiding the evacuation route through the speaker 400 installed in the fire outbreak zone.

If the manager checks the evacuation route shown in FIG. 5 and inputs the voice for guiding the direction of the evacuation route into the manager's mobile phone 100, the manager's mobile phone 100 transmits the evacuation-route guidance voice to the fire-signal receiving section 200 in real time, and the fire-signal receiving section 200 outputs the received evacuation-route guidance voice through the speaker 400 of the fire outbreak zone, thus helping people in the relevant zone to be evacuated.

Meanwhile, when estimating the evacuation route along which people may be evacuated from the fire outbreak zone to the emergency exit, the fire disaster prevention application 150 of the manager's mobile phone 100 utilizes the position information of each zone in the building and the position information of the emergency exit, which are previously registered and stored. Thus, the fire disaster prevention application 150 may determine the shortest route along which people may evacuate from the fire outbreak zone to the emergency exit. For example, the manager's mobile phone 100 previously registers and stores information about the position of each zone of the building to be managed and information about the position of the emergency exit. Thus, if the fire breaks out in the fourth zone, it is possible to estimate the shortest route for evacuating people to the emergency exit which is the nearest to the fourth zone.

In addition, when estimating the evacuation route, the fire outbreak state may be checked in real time and thus the evacuation route may be estimated. In an early stage of fire, people may be guided through a zone with relatively low flame. Thus, the evacuation route is estimated to allow people in the fire outbreak zone to be evacuated through the low flame zone.

To this end, the fire disaster prevention application 150 of the manager's mobile phone 100 estimates a percentage of a flame image occupied in the zone in the CCTV image of each zone, namely, a percentage of flame in the zone. A ratio of the distribution area of the flame of the CCTV image to the size of the zone is estimated for each zone as the flame percentage in the zone. For example, according to the analysis result of the CCTV image of the fourth zone where fire breaks out, if the percentage of the area where flame occupies in the total area of the image is 20%, the percentage of the flame of the fourth zone is estimated to be 20%. Meanwhile, if the percentage of the area where flame occupies in the total area of the image is 60%, the percentage of the flame of the fourth zone is estimated to be 60%.

After the estimation, among a plurality of routes along which people may be evacuated from the fire outbreak zone to the emergency exit, a route is estimated to allow people to pass through a zone which is smaller in the flame percentage in the zone than a preset threshold. For example, when fire breaks out in the fourth zone and spreads to adjoining zones, namely, a fifth zone, a seventh zone, and an eighth zone, as illustrated in FIG. 7, the evacuation route may be guided to allow people to escape through a relatively safe route. Therefore, people in the fire outbreak zone can be safely evacuated through the low flame zone.

According to the embodiment of the present invention, a fact that a fire breaks out can be rapidly propagated to external concerned people using a mobile-phone app of a mobile communication network. Furthermore, according to the embodiment of the present invention, internal situations can be precisely estimated at a remote location through a simultaneous call between managers who are present in a building and have mobile phones in which apps are installed. It is possible to rapidly cope with the fire in an early stage and to rapidly evacuate people in the scene of a fire to a safe place, by making an announcement while watching a CCTV screen based on the internal situations.

While the invention has been shown and described with reference to exemplary embodiments thereof, it will be understood by those skilled in the art that various changes in form and details may be made therein without departing from the spirit and scope of the invention as defined by the appended claims.

What is claimed is:

1. A remote disaster prevention system comprising:
a fire detector installed in each zone of a building to detect a fire and transmit a detected result to a fire-signal receiving section; a CCTV camera installed in each zone of the building to transmit a photographed CCTV image to the fire-signal receiving section; the fire-signal receiving section coupled to the fire detector and the CCTV camera installed in each zone to notify a fire outbreak message including a fire outbreak zone and the CCTV image to a manager's mobile phone when a fire is detected from the fire detector; a manager's mobile phone that is a mobile phone used by a manager and displays the fire outbreak message received from the fire-signal receiving section and a CCTV image of the fire outbreak zone; and a mobile communication network configured to provide mobile communication between the fire-signal receiving section and the manager's mobile phone,
wherein the fire-signal receiving section transmits a building-zone image with zones being separately marked, the manager's mobile phone displays a fire outbreak zone in the building-zone image such that it is different from other zones where no fire breaks out, the manager's mobile phone displays the CCTV image of a fire outbreak zone that is touched, when the fire outbreak zone in the building-zone image is touched, the manager's mobile phone estimates an evacuation route to allow people to be evacuated from the fire outbreak zone to an emergency exit, thus displaying the evacuation route in the building-zone image, and the manager's mobile phone previously registers and stores position information of each zone in the building and position information of the emergency exit, and estimation of the evacuation route may determine a shortest route along which people may be evacuated from the fire outbreak zone to the emergency exit.

2. The remote disaster prevention system of claim 1, wherein the estimation of the evacuation route estimates a flame percentage in each zone, which is a percentage of an image size of flame occupied in the zone, using the CCTV image of each zone, determines a route to allow people to pass through a zone which is lower in flame percentage than a preset threshold, among a plurality of routes along which people are evacuated from the fire outbreak zone to the emergency exit, and the estimated route is output to a speaker through a manager's voice for guiding the evacuation route.

3. The remote disaster prevention system of claim 1, wherein the remote disaster prevention system comprises a speaker installed in each zone of the building, the manager's mobile phone displays the CCTV image and a voice guidance button, and the manager's guidance voice for guiding people to the evacuation route is transmitted to the fire-signal receiving section after the voice guidance button is pressed down, and the fire-signal receiving section outputs the manager's voice for guiding the evacuation route through the speaker installed in the fire outbreak zone.
